(19) United States
(12) Patent Application Publication
(10) Pub. No.: US 2026/0285083 A1
(43) Pub. Date: Sep. 24, 2026

(54) AUTOMATIC DESKTOP SAND TABLE

(71) Applicant: GROUNDED LABS INC., Newark, DE (US)

(72) Inventors: Zachary Frew, Cambridge, MA (US); Jose Carlos Veloso de Oliveira Junior, Salem, NH (US)

(21) Appl. No.: 19/309,546

(22) Filed: Aug. 25, 2025

Related U.S. Application Data
(60) Provisional application No. 63/775,691, filed on Mar. 21, 2025.

(51) Int. Cl. B44D 2/00

(52) U.S. Cl. CPC B44D 2/00

(57) ABSTRACT

Aspects and embodiments disclosed herein include a kinetic art table including a mechanical gantry configured to position a magnet within a two-dimensional circle. The mechanical gantry comprises a base, a rod mount rotatably coupled to the base, a guide rod coupled to the rod mount and disposed above an upper surface of the rod mount, a carriage mounted on the guide rod and displaceable along the guide rod, a magnet coupled to the carriage, and an endless belt having a portion coupled to the carriage and engaging a portion of a drive gear extending above an upper surface of the rod mount, the drive gear configured to displace the endless belt and cause the carriage to be displaced along the guide rod.

### CROSS-REFERENCE TO RELATED APPLICATION

This application claims priority to U.S. Provisional Patent Application Ser. No. 63/775,691, filed on Mar. 21, 2025 and titled “AUTOMATIC DESKTOP SAND TABLE,” the entire disclosure of which is hereby incorporated herein by reference in its entirety for all purposes.

### BACKGROUND

### Technical Field

Embodiments of this disclosure relate to a kinetic art table including a mechanical gantry configured to position a magnet within a two-dimensional circle.

### BRIEF DESCRIPTION OF THE DRAWINGS

Embodiments of this disclosure will now be described, by way of non-limiting example, with reference to the accompanying drawings.

FIG. 1 is a schematic cross-sectional view of an embodiment of an automatic desktop sand table as disclosed herein;

FIG. 2 is a perspective view of an embodiment of an automatic desktop sand table as disclosed herein illustrating an example of a pattern that may be autonomously formed in sand on an upper platform of the automatic desktop sand table;

FIG. 3 is a perspective view of an example of a mechanical gantry for moving a magnet below the platform of an embodiment of an automatic desktop sand table as disclosed herein;

FIG. 4 is a plan view of an example of a mechanical gantry for moving a magnet below the platform of an embodiment of an automatic desktop sand table as disclosed herein; and

FIG. 5 illustrates a mechanism for centering the mechanical gantry of an embodiment of an automatic desktop sand table as disclosed herein.

### DETAILED DESCRIPTION OF CERTAIN EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

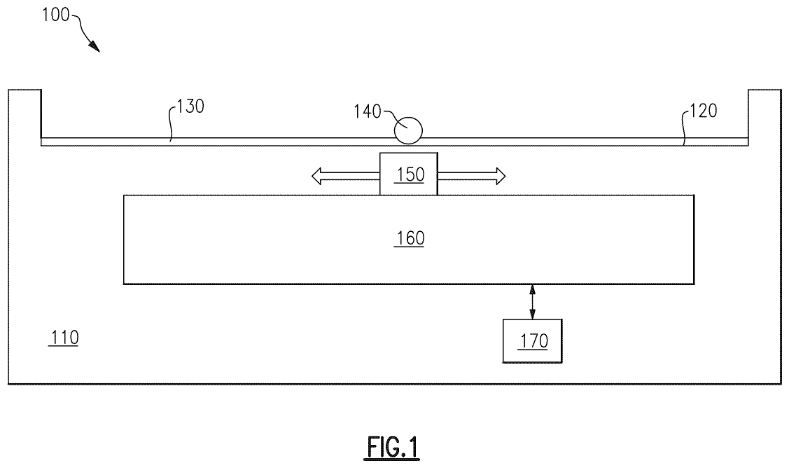

Aspects and embodiments disclosed herein include a kinetic art sand table including a platform supporting a thin layer of sand or other granular substance and a small ball that is magnetically displaced across the surface of the platform to create decorative patterns in the layer of sand. As illustrated schematically in cross-sectional view in FIG. 1, one example of a kinetic art sand table, indicated generally at 100, includes a base 110 that supports a platform 120. The platform 120, in some embodiments, may be an upper wall of the base 110. In use, a thin layer of fine sand or other granular substance 130 (hereinafter referred to simply as sand 130) is disposed on top of the platform 120 along with a small metallic ball 140. The metallic ball 140 may comprise or consist of a ferromagnetic or ferrimagnetic material, for example, stainless steel (e.g., 440C stainless steel) or chrome plated steel. In some embodiments, the sand may comprise or consist of 220 grit alumina and the metallic ball 140 may range in size from 6 mm-14 mm, for example, 12 mm. A magnet 150 is disposed within the base 110 and magnetically couples through the platform 110, which is formed of material such as an engineering plastic or a non-magnetic metal such as aluminum, to the metallic ball 140. The magnet 150 (or cover or package enclosing the magnet) may mechanically contact the lower surface of the platform 110, but need not mechanically contact the lower surface of the platform 110. The magnet 150 may magnetically couple to the metallic ball 140 even with a small gap between the magnet 150 (or magnet package) and platform 110 (and the metallic ball 140). In other embodiments, the ball 140 may be magnetic and element 150 may be a piece of ferromagnetic or ferrimagnetic material, for example, a piece of iron, however, embodiments of the sand table 100 will be described herein in which the metallic ball 140 includes or consists of a ferromagnetic or ferrimagnetic material and element 150 is a magnet.

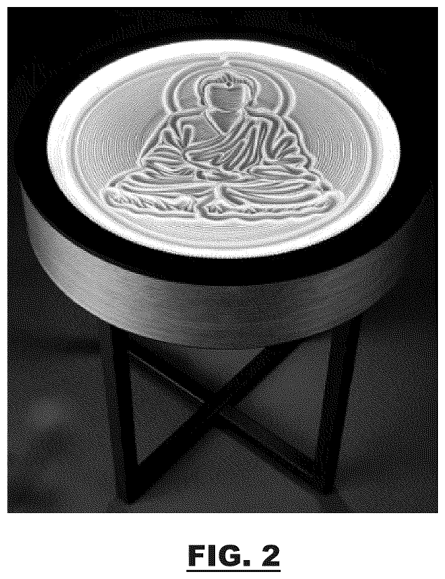

A displacement mechanism, referred to herein as a mechanical gantry 160, described in further detail below, is also disposed within the base 110 and is used to move the magnet 150 about below the bottom surface of the platform 120. The magnet 150, in turn, moves the metallic ball 140 across the upper surface of the platform 120 to create a pattern in the sand 130. (See FIG. 2.) In some embodiments, the platform 120 is circular or disc-shaped and the mechanical gantry 160 may be configured to move the metallic ball 140 anywhere within the area defined by the surface of the platform 120 with the magnet 150. In other embodiments, the platform 120 may be oval or polygonal. Movement of the magnet 150 by the mechanical gantry 160 may be controlled by a controller 170 also disposed within the base 110. In some embodiments, the controller 170 may be a programmable logic controller, application specific integrated circuit, or other appropriate form of controller as might be selected by one of ordinary skill in the art, and may include functionality to be wirelessly/remotely programmed utilizing an app on a smartphone or remotely located computer.

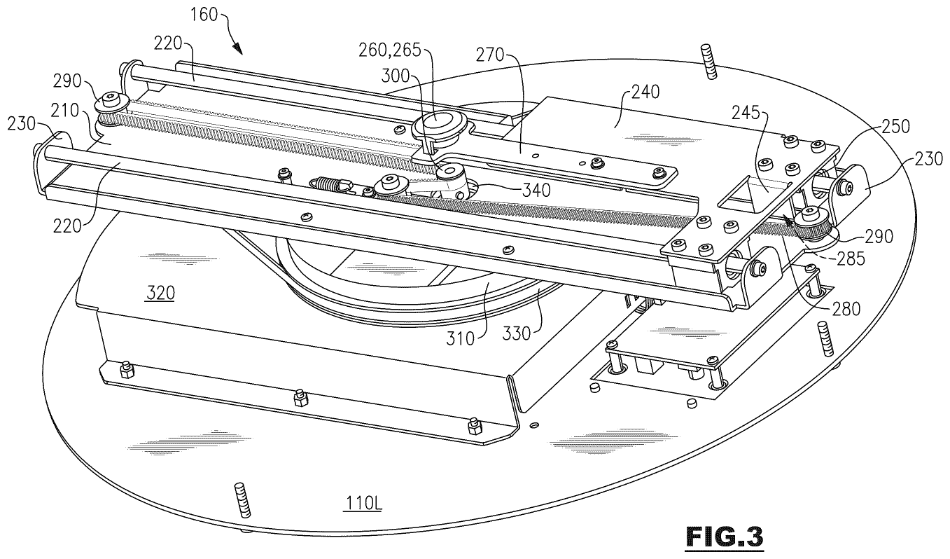

FIG. 3 illustrates an embodiment of a mechanical gantry 160 for a sand table 100 as disclosed herein mounted on a lower wall 110L of the base 110 and with sidewalls of the base 110 and the platform 120 omitted from the figure. The mechanical gantry 160 includes a rod mount 210 rotatably coupled to the base 110. The rod mount 210 may be a generally rectangular plate. One or more guide rods 220 (two guide rods 220 in the embodiment of FIG. 3) are coupled to the rod mount 210 and disposed above an upper surface of the rod mount 210. The one or more guide rods 220 may be coupled to the rod mount by one or more brackets 230 that extend upward from the upper surface of the rod mount 210. The brackets 230 may be disposed at opposite terminal ends of the rod mount 210 and the one or more guide rods 220 may thus extend across an entirety or substantially an entirety of the length of the rod mount. The one or more guide rods 220 may be straight and arranged parallel to one another as illustrated in FIG. 3, but in other embodiments may be curved.

The mechanical gantry 160 includes a carriage 240 mounted on the one or more guide rods 220 and displaceable along the one or more guide rods 220. The carriage 240 may include a carriage plate with one or more linear bearings 250 mounted to the lower surface of the carriage plate by, for example, one or more fasteners such as screws, bolts, clips, or other fasteners known in the art or by an adhesive. The one or more guide rods 210 may pass through the one or more linear bearings 250 to provide for the carriage 240 to slide along the one or more guide rods 210.

A magnet 260, such as magnet 150 of FIG. 1, is coupled to the carriage 240, for example, to an upper surface of the carriage 240 by a magnet mount 270. The magnet mount 270 may include an elongate plate with the magnet 260 disposed on one end of the elongate plate and the other end of the elongate plate coupled to the carriage 240 by, for example, one or more fasteners such as screws, bolts, clips, or other fasteners known in the art or by an adhesive. In some embodiments, the magnet 260 may be disposed within a magnet cover 265 that is coupled to the carriage by, for example, one or more fasteners such as screws, bolts, clips, or other fasteners known in the art or by an adhesive. The magnet 260 may be a permanent magnet, for example, an iron-based permanent magnet or a rare earth magnet including an element such as neodymium. Alternatively, the magnet 260 may be an electromagnet that may be turned on or off by the controller 170 of the sand table 100.

An endless belt 280 has a portion 285 coupled to the carriage 240, for example, by a tab 245 extending from an upper or lower surface of the carriage 240 and having a distal end mechanically secured to the portion 285 of the endless belt 180 by one or more fasteners such as screws, bolts, clips, or other fasteners known in the art or by an adhesive. The portion 285 of the endless belt 280 may extend parallel to the one or more guide rods 220 to facilitate smooth linear displacement of the carriage 240 along the one or more guide rods 220 by movement of the endless belt 280. The endless belt 280 is supported above the upper surface of the rod mount 210 by passing about one or more idlers 290 and engages a portion of a linear drive gear 300 extending above an upper surface of the rod mount 210. The portion 285 of the endless belt 280 that extends parallel to the one or more guide rods 220 extends between a first idler 290 disposed on the upper surface of the rod mount 210 and a second idler 290 disposed on the upper surface of the rod mount 210. The linear drive gear 300 is configured to rotate and displace the endless belt 280 which in turn pulls the carriage 240 along the one or more guide rods 210. Displacement of the endless belt 280 and carriage 240 by rotation of the linear drive gear 300 may provide for displacement of the magnet 260 through range of motion that extends from a center of the rod mount 210 to an edge of the rod mount 210. In some embodiments, as shown in FIG. 3, one side the endless belt 280 has teeth that may engage complimentary teeth (not visible in FIG. 2) on the linear drive gear 300. The side of the endless belt 280 that engages the one or more idlers 290 may be smooth to reduce friction between the endless belt 280 and the one or more idlers 290.

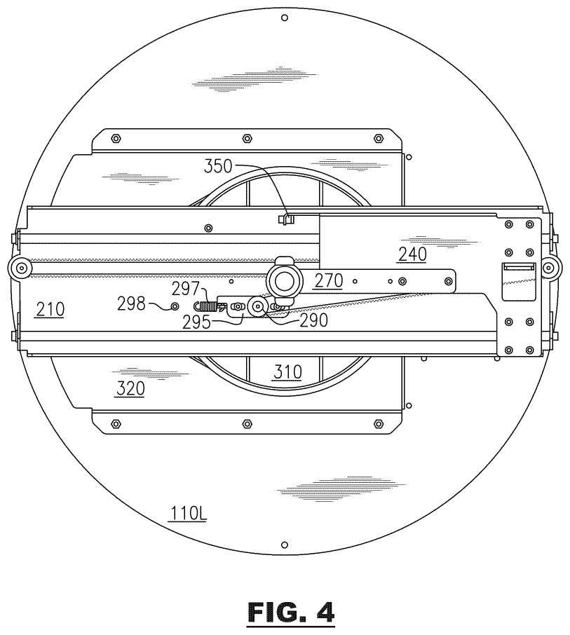

As more clearly illustrated in FIG. 4, at least one of the one or more idlers 290 may be mounted on an idler plate 295 that is slidably displaceable over the upper surface of the rod mount 210. A tension spring 297 is disposed on the rod mount 210 with one end fixed in place on the rod mount 210 via a fastener 298 such as a screw or bolt (tension spring 297 shown unattached to the fastener 298 in FIG. 4) and the other end mechanically coupled to the idler plate 295. The tension spring 297 is configured to bias the at least one of the one or more idlers 290 in a direction that reduces slack in the endless belt 280, for example, to the left when oriented as illustrated in FIG. 4.

To enable movement of the magnet 260 not only back and forth along the one or more guide rods 220, but also to different circumferential positions beneath the platform 120, the rod mount 210 may itself be disposed on a radial drive gear 310 configured to rotate the entire rod mount 210 (and features included in or connected to the rod mount 210) relative to the base 110. The radial drive gear 310 may be configured to rotate the rod mount 210 over a range of motion of at least 180° relative to the base 110 or over a range of motion of 360° relative to the base 110. The radial drive gear 310 may be in the form of a circular plate or annulus upon which the rod mount 210 is disposed. The radial drive gear 310 is rotatably disposed on a motor mount 320 that, in turn, is fixed to the upper surface of the lower wall 110L of the base 110. The radial drive gear 310 is rotated by a bottom belt 330 driven by a bottom belt drive motor (obscured by the rod mount 210 and not visible in FIG. 3 or 4). In some embodiments, the drive motor for the linear drive gear 300 and the bottom belt drive motor may be disposed within the motor mount 320, with drive shafts extending above the upper surface of the motor mount 320 (for the bottom belt drive motor) and/or above the upper surface of the rod mount 210 (for the linear drive gear 300) to engage their respective belts. The drive motor for the drive gear 300 and the bottom belt drive motor may be stepper motors or encoded DC motors to provide for precise control and determination of the positions of the rod mount 210 and the radial drive gear 310. In some embodiments, the linear drive gear 300/shaft of the drive motor for the linear drive gear 300 may extend upward from the motor mount 320 through an aperture defined centrally within the radial drive gear 310 (obscured by the rod mount 210 in FIGS. 2 and 3) and through an aperture 340 defined in the rod mount 210 (See FIG. 3).

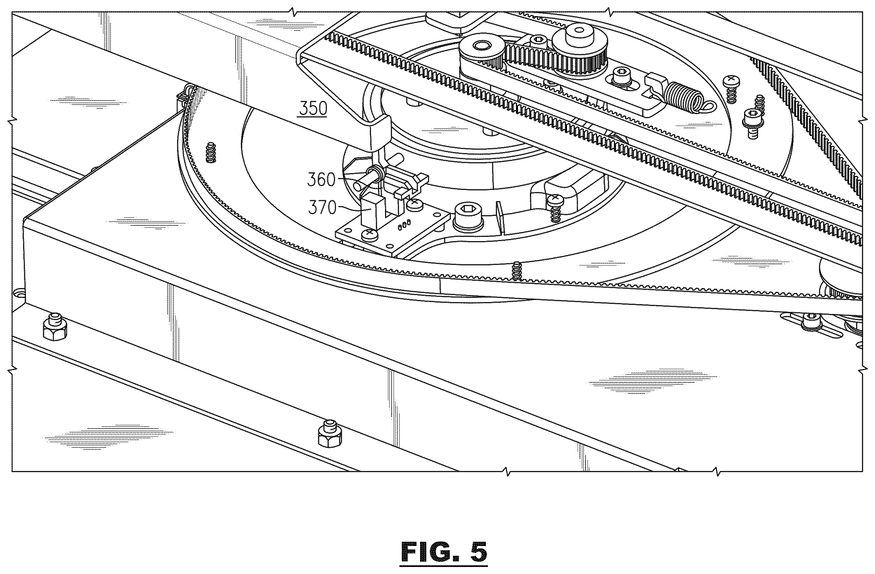

In some embodiments, the mechanical gantry 160 may include one or more features that may be used to calibrate a location of the magnet 260 at a center of the rod mount 210 and/or platform 120. In some embodiments, the carriage 240 includes an indexing tab 350 extending from the front of the carriage (the left side of the carriage in the orientation shown in FIGS. 3 and 4). When the carriage 240/magnet 260 is in its center or “home” position, a lower the portion of the indexing tab 350 engages a spring loaded flag 360 and rotates the spring loaded flag 360 relative to a limit switch 370, which maybe an optical limit switch. (See FIG. 5 in which the rod mount 210 and radial drive gear are 310 omitted to show the spring loaded flag 360 and limit switch 370.) The limit switch 370 detects the rotation of the spring loaded flag and provides a signal to the controller 170 which records the position of the linear drive gear 300 as that at which the carriage 240/magnet 260 are in the center or home position.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure.

What is claimed is:

1. A kinetic art table including a mechanical gantry configured to position a magnet within a two-dimensional circle, the mechanical gantry comprising:
a base;
a rod mount rotatably coupled to the base;
a guide rod coupled to the rod mount and disposed above an upper surface of the rod mount;
a carriage mounted on the guide rod and displaceable along the guide rod;
a magnet coupled to the carriage; and
an endless belt having a portion coupled to the carriage and engaging a portion of a drive gear extending above an upper surface of the rod mount, the drive gear configured to displace the endless belt and cause the carriage to be displaced along the guide rod.

2. The kinetic art table of claim 1, further comprising one or more idlers disposed on the upper surface of the rod mount, the endless belt passing around the one or more idlers.

3. The kinetic art table of claim 2, further comprising a tension spring disposed on the rod mount and configured to bias the at least one of the one or more idlers in a direction that reduces slack in the endless belt.

4. The kinetic art table of claim 2, further comprising a plurality of idlers disposed on the upper surface of the rod mount, the endless belt passing around the plurality of idlers.

5. The kinetic art table of claim 1, wherein the endless belt includes teeth that engage complimentary teeth on the drive gear.

6. The kinetic art table of claim 1, further comprising a magnet mount mechanically coupling the magnet to the carriage.

7. The kinetic art table of claim 1, wherein the rod mount is disposed on a radial drive gear configured to rotate the rod mount relative to the base.

8. The kinetic art table of claim 7, wherein the rod mount is disposed on a radial drive gear configured to rotate the rod mount over a range of motion of at least 180° relative to the base.

9. The kinetic art table of claim 7, wherein the rod mount is disposed on a radial drive gear configured to rotate the rod mount over a range of motion of 360° relative to the base.

10. The kinetic art table of claim 1, further comprising a platform disposed above the mechanical gantry, the mechanical gantry configured to displace a ball formed of a magnetic material over an upper surface of the platform with the magnet.

11. The kinetic art table of claim 1, wherein a range of motion of the magnet extends from a center of the rod mount to an edge of the rod mount.

12. The kinetic art table of claim 1, wherein two-dimensional circle is within a plane parallel to one of an upper surface or a lower surface of the base, and the mechanical gantry is configured to move the magnet to any position within the two dimensional circle.

13. The kinetic art table of claim 1, wherein the guide rod is linear.

14. The kinetic art table of claim 13, wherein a portion of the endless belt extends parallel to the guide rod.

15. The kinetic art table of claim 14, wherein the portion of the endless belt extends between a first idler disposed on the upper surface of the rod mount and a second idler disposed on the upper surface of the rod mount.

16. The kinetic art table of claim 1, wherein the carriage is mounted on the guide rod by a linear bearing.

17. The kinetic art table of claim 1, further comprising a second guide rod, the carriage being mounted on both the guide rod and the second guide rod.
